(19) United States
(12) Patent Application Publication
(10) Pub. No.: US 2025/0294032 A1
(43) Pub. Date: Sep. 18, 2025

(54) System and Related Method for the Spatial Marking of a Multimedia File

(71) Applicant: ERASMICOIN S.R.L., Roma (IT)

(72) Inventor: Michele Donatacci, Roma (IT)

(73) Assignee: ERASMICOIN S.R.L., Roma (IT)

(21) Appl. No.: 19/083,081

(22) Filed: Mar. 18, 2025

(30) Foreign Application Priority Data
Mar. 18, 2024 (IT) 102024000005908

(51) Int. Cl. H04L 9/40; G01S 19/42

(52) U.S. Cl. CPC H04L 63/123; G01S 19/42

(57) ABSTRACT

A spatial marking system is provided including: a ground-based global navigation satellite receiver, an application server and an installable client configured to receive signals from at least three Galileo satellites. The client is configured to generate and/or modify a multimedia file, generate geolocation metadata comprising a position calculated by a global navigation satellite receiver, associate the geolocation metadata with the multimedia file and receive Galileo E1-B channel I/NAV messages from at least three Galileo satellites associated with the position calculated. The ground-based global navigation satellite receiver is configured to receive Galileo E1-B channel I/NAV messages from at least three Galileo satellites and timestamps from a trusted Network Time Protocol server. The application server is configured to generate a validation outcome relating to the geolocation metadata based on a comparison between the OSNMA messages extracted from the I/NAV messages of the ground-based global navigation satellite receiver and an electronic device.

### CROSS-REFERENCE TO RELATED APPLICATIONS

This patent application claims priority from Italian patent application no. 102024000005908 filed on Mar. 18, 2024, the entire disclosure of which is incorporated herein by reference.

### TECHNICAL FIELD

This invention concerns a system and a related method for the spatial marking of a multimedia file.

### STATE OF THE ART

As is known, the Galileo positioning system is the Global Navigation Satellite System (GNSS) of the European Space Agency (ESA), which provides a highly accurate positioning service with global coverage. Currently, the Galileo system comprises several satellites positioned on three circular planes in Medium Earth Orbit (MEO) at an altitude of 23.222 km above the Earth and with an inclination of the orbital planes of 56 degrees with respect to the equator.

In general, the acronym GNSS refers to a satellite constellation that transmits position and time data to GNSS receivers (e.g., ground-based, smartphone, or vehicle-based ones, etc.) so that the latter use these position and time data to determine their position.

### OBJECT OF THE INVENTION

The aim of the present invention is to provide a secured and certified spatial marking of a multimedia file, in particular based on signals transmitted by Galileo satellites to global navigation satellite receivers (also known as GNSS receivers).

This and other aims are achieved by the present invention as it relates to a system and a related method for the spatial marking of a multimedia file, as defined in the appended claims.

In particular, the present invention relates to a spatial marking system of a multimedia file that includes:
a ground-based global navigation satellite receiver configured to receive signals from at least three Galileo satellites;
an application server;
an installable client on an electronic device capable of communicating with remote devices/systems via one or more wired and/or wireless networks/technologies and equipped with/connected to a global navigation satellite receiver configured to receive signals from at least three Galileo satellites;
the ground-based global navigation satellite receiver being configured to:
receive:
   Galileo E1-B channel I/NAV messages from at least three Galileo satellites and
   timestamps from a trusted Network Time Protocol server;
transmit to the application server:
   Galileo E1-B channel I/NAV messages received from the at least three Galileo satellites, and
   the timestamps received from the trusted Network Time Protocol server;
the client is operable by a user and/or configured to:
generate and/or modify the multimedia file;
generate a geolocation metadata comprising a position calculated by the global navigation satellite receiver of the electronic device on which the client is installed;
associate the geolocation metadata with the multimedia file generated and/or modified;
receive:
   Galileo E1-B channel I/NAV messages from at least three Galileo satellites associated with the position calculated;
   a timestamp associated with the multimedia file from the trusted Network Time Protocol server; and
transmit to the application server:
   the Galileo E1-B channel I/NAV messages, the geolocation metadata, the timestamp and the multimedia file generated and/or modified;
the application server being configured to:
extract OSNMA messages from the I/NAV messages received from the ground-based global navigation satellite receiver;
extract a Galileo System Time field from the I/INAV messages received from the ground-based global navigation satellite receiver;
validate OSNMA messages extracted from the I/NAV messages received by the ground-based global navigation satellite receiver by applying a TESLA protocol;
receive from the electronic device:
   the Galileo E1-B channel I/NAV messages,
   the geolocation metadata,
   the timestamp and
   multimedia file generated and/or modified;
extract OSNMA messages from I/NAV messages received by the electronic device;
compare an OSNMA message extracted from an I/NAV message received by the electronic device with an OSNMA message extracted from an I/NAV message received by the ground-based global navigation satellite receiver and validated using the TESLA protocol, said OSNMA messages having the same Galileo satellite identification and having the same timestamp; said timestamps being compatible, minus a time delta, with the Galileo System Time field extracted by the I/INAV messages received from the ground-based global navigation satellite receiver; and
generate a validation outcome relating to the geolocation metadata based on this comparison.

The present invention also relates to a method for spatial marking of a multimedia file comprising the steps of:
a) extracting a Galileo System Time field from the I/INAV messages transmitted to a ground-based global navigation satellite receiver by at least three Galileo satellites;
b) extracting the OSNMA messages from the I/INAV messages of the Galileo E1-B channel transmitted to the ground-based global navigation satellite receiver by at least three Galileo satellites;
c) validating the OSNMA messages extracted from the I/INAV messages transmitted to the ground-based global navigation satellite receiver from at least three Galileo satellites using a TESLA protocol;
d) extracting the OSNMA messages from the I/NAV messages of the Galileo E1-B channel transmitted by at least three Galileo satellites to an electronic device;
e) comparing the OSNMA messages from the ground-based global navigation receiver with the OSNMA messages from the electronic device; said OSNMA messages from the ground-based global navigation receiver and from the electronic device having the same Galileo satellite identifier and having the same timestamp; said timestamp being compatible, minus a time delta, with the Galileo System Time field extracted;
f) generating a validation outcome concerning a geolocation metadata associated with the multimedia file on the basis of this comparison; said geolocation metadata comprising a position calculated by a global navigation satellite receiver of the electronic device; and
g) storing, on a blockchain system, the generated validation outcome, the I/NAV messages of the ground-based global navigation satellite receiver, the I/NAV messages of the electronic device, the timestamps and the multimedia file.

### BRIEF DESCRIPTION OF THE DRAWINGS

In order to better understand this invention, some preferred embodiments (provided merely by way of example but absolutely non-limiting) will now be described with reference to the accompanying drawings (not all to scale) wherein:

FIG. 1 schematically illustrates an architecture of a spatial marking system according to an embodiment of the present invention;

FIG. 2 schematically illustrates a structure of an Integrity Navigation Message (I/NAV) for E-1B signals according to the state of the art;

FIG. 3 schematically illustrates an Open Service Navigation Message Authentication (OSNMA) according to the state of the art;

FIG. 4 schematically illustrates the validation by comparison of OSNMA messages according to an embodiment of the present invention;

FIG. 5 schematically illustrates the validation of an OSNMA message by applying a TESLA protocol according to the state of the art; and

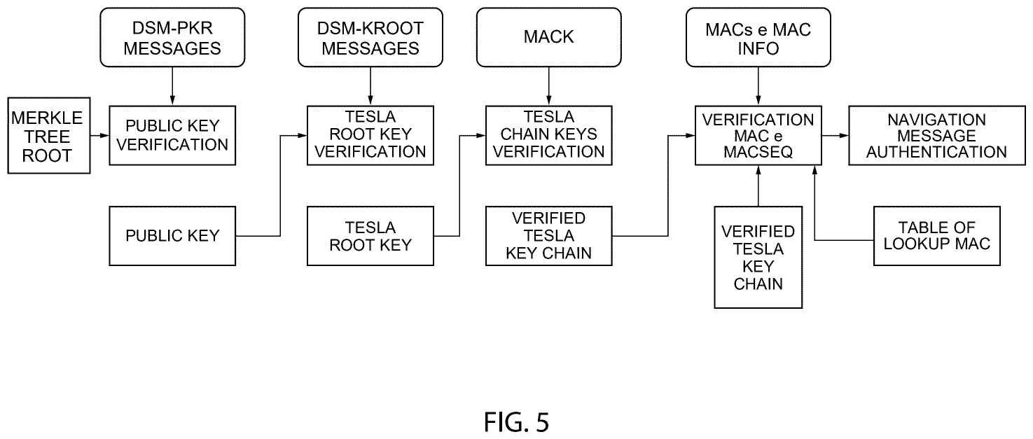

FIG. 6 schematically illustrates a block diagram of the method according to the present invention.

### DESCRIPTION OF THE INVENTION

The following description is provided to enable a person skilled in the art to make and use the invention. Various modifications to the embodiments set forth will be immediately clear to the persons skilled in the art and the general principles herein disclosed may be applied to other embodiments and applications without, however, departing from the protection scope of the present invention as defined in the appended claims.

Therefore, the present invention should not be understood as limited to the sole embodiments described and shown, but it must be given the widest scope of protection in accordance with the characteristics defined in the appended claims.

In the following description, explicit reference will be made to the use of one or more smartphones merely by way of non-limiting and non-binding example.

Indeed, this invention can be used with any fixed or mobile (e.g., portable or wearable) electronic device equipped with/connected to a global navigation satellite receiver (also referred to as a GNSS receiver) configured to receive signals from at least three Galileo satellites and capable of communicating with remote devices/systems via one or more wired and/or wireless networks/technologies, e.g., a smartphone including the client installed on the smartphone itself.

By way of example, a multimedia file is a video, an audio file, a photo, a text file, a document of any format: .pdf, .docx, .ppt etc., a Non-Fungible Token (NFT), a Smart Contract, etc.

The spatial marking of the multimedia file includes:
attaching to the multimedia file: a geolocation metadata including a position calculated by the global navigation satellite receiver of the smartphone on which the client is installed, an identification metadata and a timestamp;
validating the identification metadata and the timestamp at the source;
storing the multimedia file, the identification metadata, the timestamp, preferably a hash of the multimedia file, the geolocation metadata, the I/NAV messages and a digital spatial marking certificate on a blockchain system; and
guaranteeing confidentiality, integrity, availability, authenticity and non-repudiation of the multimedia file, and any associated metadata.

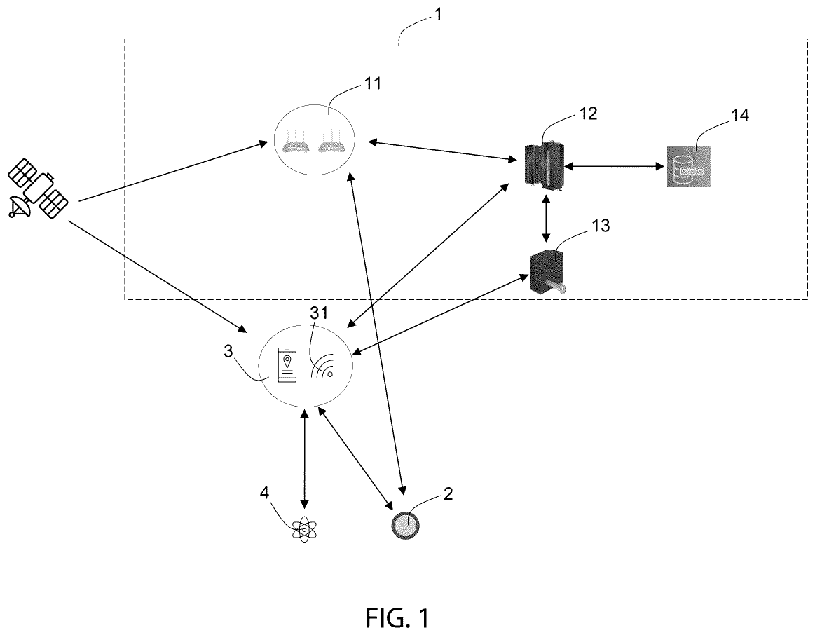

FIG. 1 schematically illustrates an architecture of the spatial marking system according to an embodiment of the present invention.

The spatial marking system 1 according to this invention is configured to, as described in detail below:
validate the geolocation metadata based on Open Service Navigation Messages Authentication (OSNMA) messages from the Galileo E1-B satellite constellation;
validate at the source the identification metadata generated by an Identity Trusted Provider; and
validate at the source the timestamp generated by a trusted Network Time Protocol (NTP) server;
preferably associate the metadata and timestamp with the multimedia file when generating and/or modifying the multimedia file itself; and
store in a blockchain system the multimedia file, the geolocation metadata, the I/NAV messages of the ground-based receiver and electronic device, the identification metadata, the timestamp associated with the multimedia file already validated at the source, preferably the hash of the multimedia file, the digital spatial marking certificate obtained as a result of the OSNMA message validation checks, to guarantee confidentiality, integrity, availability, authenticity and non-repudiation.

As illustrated in FIG. 1, the spatial marking system 1 includes a ground-based global navigation satellite receiver 11 (hereinafter referred to as a ground-based GNNS receiver 11) configured to receive:
Galileo E1-B channel Integrity Navigation (I/NAV) messages from at least three Galileo satellites; and
timestamps from a trusted Network Time Protocol (NTP) server 2.

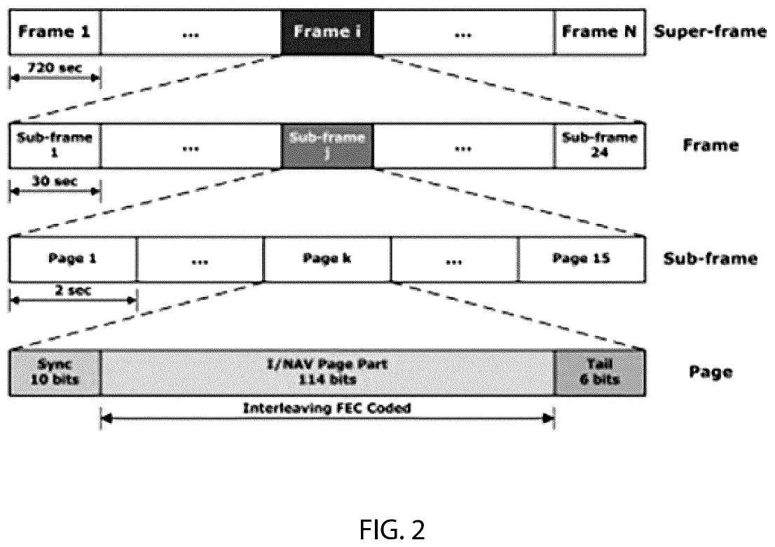

FIG. 2 schematically illustrates the structure of an Integrity Navigation Message (I/NAV) for E1-B signals according to the state of the art; for this reason, it was deemed superfluous to describe FIG. 2 since known to a person skilled in the art.

The ground-based GNSS receiver 11 transmits I/NAV messages and timestamps to an application server 12.

The application server 12 is configured to extract Open Service Navigation Messages Authentication (OSNMA) messages and a Galileo System Time (GST) value from the I/NAV messages received from the ground-based GNSS receiver 11. These OSNMA messages are then validated by applying a TESLA protocol.

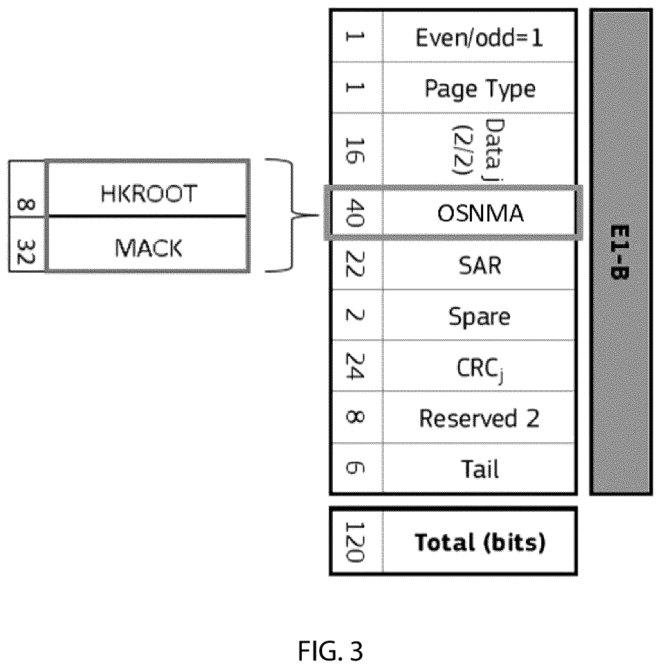

FIG. 3 schematically illustrates the Galileo authentication OSNMA messages according to the state of the art; in particular, FIG. 3 schematically illustrates the bits of the OSNMA message that can be extracted from E1-B I/NAV messages according to the state of the art; for this reason, it was deemed superfluous to describe FIG. 3 since is known to a person skilled in the art.

The spatial marking system 1 exploits the OSNMA messages that enable the sending of cryptographic signatures together with navigation data transmitted by Galileo satellites for validating geolocation metadata to be associated with the multimedia files.

The OSNMA function is a position data authentication function for Galileo Open Service global users that is freely accessible to all and, by transmitting specific authentication data in previously reserved fields of the E1 I/NAV message, provides GNSS receivers (e.g. ground-based GNNS receivers 11, smartphones 3 equipped with their own GNSS chipsets or external GNSS devices 31 connected to smartphones) with a guarantee that the Galileo navigation message received comes from the system itself and has not been modified.

In this way, a GNSS receiver receiving these data can check the signatures against a public key and ensure that the data come from the Galileo constellation and not from a third party that could falsify the signals transmitted by the satellites.

In particular, the OSNMA messages use the TESLA cryptographic protocol, which reduces the size of the signatures to be sent.

Specifically, instead of using public key cryptography to sign data, data are signed using symmetric key cryptography, e.g. hash-based message authentication codes (HMAC), where these signatures can be quite short. The symmetric keys used to generate these signatures are then disclosed by the system, once the signatures have been transmitted.

TESLA symmetric keys belong to a chain that was generated by successively applying a one-way function to the first key in the chain, wherein the keys are used and transmitted in the reverse order to how they were generated. In this way, a receiver cannot predict future keys, but if it already considers a key secure, given a new key it can check whether that new key belongs to the same chain and decide to consider the new key secure as well.

In particular, some of the keys in the chain are assigned public key cryptographic signatures (e.g., Galileo uses ECDSA), so that a recipient who only has the public key can take one of these keys, check its signature and thus begin to consider that chain secure.

The validation of the OSNMA message extracted from the I/NAV message transmitted by the Galileo satellite to the ground-based GNSS receiver 11 is performed on the application server 12 and involves:
extracting the part concerning the OSNMA message from the I/INAV message for each Galileo E1-B satellite that transmitted it to the ground-based GNSS receiver 11;
validating, using the TESLA protocol, the OSNMA message, namely:
   verifying the public key retrieved from a Digital Signature Message-Public Key Retrieval (DSM-PKR);
   verifying a TESLA root key retrieved from a Digital Signature Message-Key Root (DSM-KROOT);
   verifying a TESLA key against a root key or a previously authenticated key;
   verifying the structure of a message authentication code key (MACK), namely verifying:
      an Authentication Data & Key Delay (ADKD) sequence;
      a MAC Sequence (MACSEQ) value;
      a Flexible (FLX) tag
      verifying the ADKD 0, ADKD 4 and ADKD 12 tags; and
      authenticating the navigation data.

The client of the smartphone 3 is operable by a user and/or configured to generate and/or modify the multimedia file, generate the geolocation metadata and associate that geolocation metadata with the multimedia file generated and/or modified.

The client installed on the electronic device 3 (using its own GNSS chipset or external GNSS receivers 31 connected to it) is configured to receive:
Galileo E1-B channel I/NAV messages from at least three Galileo satellites associated with the position calculated; and
timestamps associated with the multimedia file from the trusted Network Time Protocol server 2.

These I/NAV messages, the geolocation metadata, multimedia file generated and/or modified and the timestamps associated with the multimedia file generated and/or modified are transmitted to application server 12.

The client is preferably configured to receive identification metadata relating to the multimedia file generated and/or modified, where the identification metadata is generated and transmitted to the client by an Identity Trusted Provider 4.

Specifically, the identification metadata relates to an identity of a user using an application on the smartphone 3, the identity being obtained using Trusted Services from authorised providers.

The “identity of the user”, which is in no way limiting or binding, means the association with “a natural person, a legal person or even a natural person representing the legal person” identified with sufficient reasonableness by one of the internationally recognised electronic identification systems.

According to a possible embodiment, the spatial marking system 1 comprises a public key infrastructure (PKI) type server 13 configured to generate an asymmetric key pair comprising a public key and a private key, wherein the public key is sent to the client installed on the smartphone 3 for encrypting the geolocation metadata, the I/NAV messages, the multimedia file generated and/or modified, preferably the identification metadata, preferably the hash of the multimedia file and the timestamp (associated with the multimedia file), while the private key is transmitted to the application server 12 and used by the application server 12 for decrypting the geolocation metadata, the I/NAV messages, the multimedia file generated and/or modified, preferably the identification metadata, preferably the hash of the multimedia file and the timestamp.

Thus, according to the embodiment described above, the geolocation metadata, the I/NAV messages, preferably the identification metadata, preferably the hash data, the multimedia file and the timestamp are encrypted before being transmitted to the application server 12, which decrypts them using the private key.

The application server 12 is configured to extract an OSNMA message from an I/NAV message transmitted by the smartphone 3 to the application server 12 and to compare this extracted OSNMA message with an OSNMA message extracted from an I/NAV message received from the ground-based GNSS receiver 11 and validated, as described above, using the TESLA protocol. In particular, these OSNMA messages have the same timestamp, and more specifically, the timestamps are compatible, minus a time delta, with the Galileo System Time (GST) field extracted from the I/INAV messages received from the ground-based GNSS receiver 11 and having the same Galileo satellite identifier.

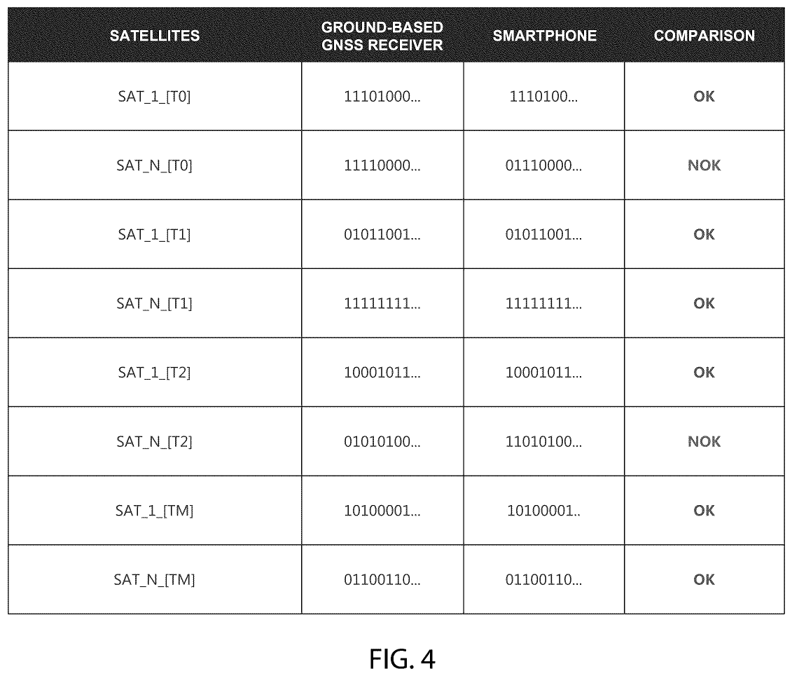

FIG. 4 schematically illustrates the validation by comparison between the OSNMA messages extracted from the I/NAV messages of the ground-based GNSS receiver 11 and the OSNMA messages extracted from the I/NAV messages of the client installed on the smartphone 3 carried out based on a comparison between a sequence of bits, preferably forty bits.

These OSNMA messages are preferably transmitted from the same satellite and have the same timestamp: if the OSNMA messages with the same timestamp (compatible, minus a time delta, with the GST field) and transmitted from the same satellite to both the ground-based GNSS receiver 11 and smartphone 3 coincide, the OSNMA message transmitted by the smartphone 3 is validated and the satellite that transmitted it is valid for the calculation of the position of the smartphone 3, so the geolocation metadata is valid.

In other words, if the timestamp of the OSNMA messages is compatible, minus a time delta, with the Galileo System Time-GST of the I/NAV message of the ground-based GNSS receiver 11, if the identifier of the satellite that transmitted the I/NAV messages to the ground-based GNSS receiver 11 and smartphone 3 coincide, and if a sequence of the 40 bits of the OSNMA messages extracted from the I/NAV messages, for each page received of the I/NAV message, coincide, the OSNMA message is validated.

According to a preferred embodiment, the geolocation metadata is validated based on a comparison of at least three OSNMA messages extracted from the I/NAV messages transmitted by three Galileo satellites to the ground-based GNSS receiver 11 and smartphone 3.

It should be noted that the OSNMA messages from the ground-based GNSS receiver 11 with which the OSNMA messages transmitted by the smartphone 3 are compared were previously validated by applying the TESLA protocol.

In other words, to use this validation process, a ground-based GNSS receiver 11 infrastructure must be built wherein the receivers validate their OSNMA message using the TESLA protocol, and then this OSNMA message validated by the ground-based GNSS receivers 11 is compared with messages transmitted by a smartphone 3 and/or external GNSS receivers 31 connected to the smartphone 3, which will in turn be validated by comparison with the former.

At this point, the application server 12 generates a validation outcome relating to the geolocation metadata based on this comparison.

As an example, the validation outcome could include a string of characters or codes representing a confirmation of a positive outcome of such a comparison.

The spatial marking system 1 comprises a blockchain system 14 configured to receive from the application server 12 and to store:
the I/NAV messages transmitted by the ground-based global navigation satellite receiver 11 to the application server 12;
the I/NAV messages transmitted by the smartphone 3 to the application server 12;
the timestamps transmitted by the ground-based global navigation satellite receiver 11 and by the smartphone 3 to the application server 12;
the multimedia file generated and/or modified;
preferably, the identification metadata;
preferably, the hash of the multimedia file;
the geolocation metadata; and
preferably, the spatial marking digital certificate.

The application server 12 is preferably configured to validate the timestamp based on the timestamps received from the ground-based GNSS receiver 11 and the smartphone 3, validate the identification metadata based on the identification metadata received from the smartphone 3, and output a digital certificate of the multimedia file generated and/or modified based on the generated validation outcome (relating to the geolocation metadata) and based on the validation of the timestamp and the identification metadata.

In particular, the identification metadata is validated at the source as it is generated by an Identity Trusted Provider 4 and the timestamp is validated at the source as it is generated by a trusted Network Time Protocol server 2.

In other words, the application server 12 is configured to handle the exchange of the multimedia file, metadata and timestamp with the smartphone 3 for validation at the source of the geolocation metadata, identification metadata and timestamp of the multimedia file.

The blockchain system 14 is preferably configured to also receive the digital certificate.

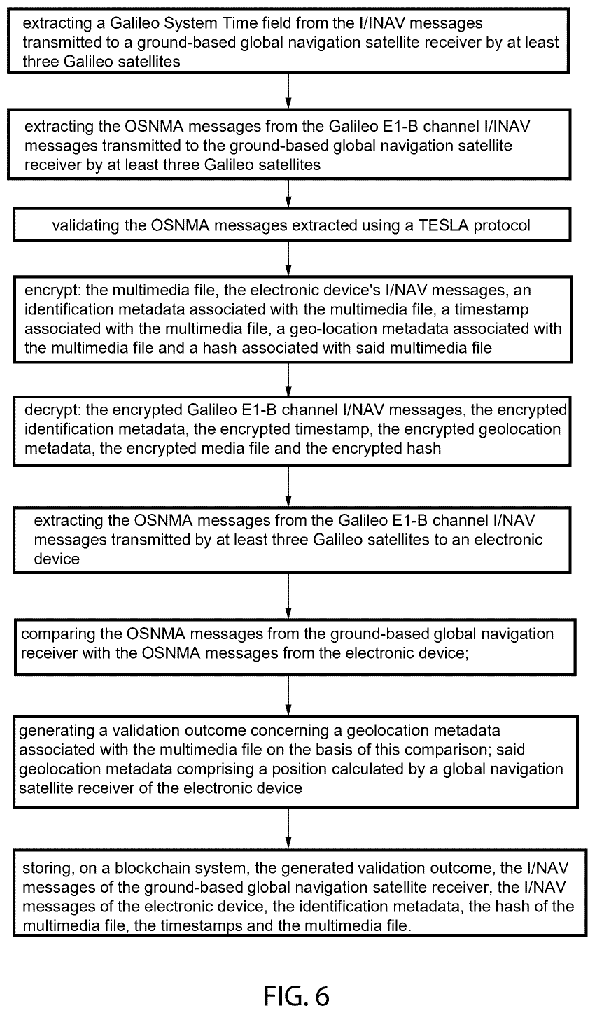

FIG. 6 schematically illustrates a block diagram relating to the phases of the method for the spatial marking of the multimedia file according to an embodiment of the present invention. As shown in FIG. 6, the method comprises the phases:
extracting a Galileo System Time field from the I/INAV messages transmitted to a ground-based global navigation satellite receiver by at least three Galileo satellites;
extracting the OSNMA messages from the I/INAV messages of the Galileo E1-B channel transmitted to the ground-based global navigation satellite receiver by at least three Galileo satellites;
validating the OSNMA messages extracted from the I/INAV messages transmitted to the ground-based global navigation satellite receiver from at least three Galileo satellites using a TESLA protocol;
preferably encrypting the multimedia file, the electronic device's I/NAV messages, an identification metadata associated with the multimedia file, a timestamp associated with the multimedia file, a geolocation metadata associated with the multimedia file and a hash associated with said multimedia file; said geolocation metadata comprising a position calculated by a global navigation satellite receiver of the electronic device;
preferably decrypting the encrypted Galileo E1-B channel I/NAV messages, the encrypted identification metadata, the encrypted timestamp, the encrypted geolocation metadata, the encrypted multimedia file and the encrypted hash;
extracting the OSNMA messages from the I/NAV messages of the Galileo E1-B channel transmitted by at least three Galileo satellites to an electronic device;
comparing the OSNMA messages of the ground-based global navigation receiver with the OSNMA messages of the electronic device; said OSNMA messages of the ground-based global navigation receiver and from the electronic device having the same Galileo satellite identifier and having the same timestamp; said timestamp being compatible, minus a time delta, with the Galileo System Time field extracted;
generating a validation outcome concerning a geolocation metadata associated with the multimedia file on the basis of this comparison; and
storing, on a blockchain system, the generated validation outcome, the I/NAV messages of the ground-based global navigation satellite receiver, the I/NAV messages of the electronic device, the timestamps, the multimedia file, preferably the identification metadata and preferably the hash.

It is worth noting that the timestamp described above is the one provided by the trusted NTP server 2 and is common to both the ground-based GNNS receiver 11 and the smartphone 3.

The system described above guarantees generating a spatial marking of the multimedia file that guarantees the validity, non-repudiation, integrity, and non-manipulability of the metadata and the files associated with said metadata, whereby the spatial marking and the certified multimedia files are available at all times upon request.

It is only fair to note that the digital certificate (thus also the spatial marking) and related files are available at any time upon request.

From the above description, the multiple innovative features of this invention are immediately apparent to a person skilled in the art.

In conclusion, it is important to note, although the invention described above makes particular reference to very specific embodiments, it is not to be considered limited to those embodiments, since it encompasses all those variants, modifications, or simplifications covered by the attached claims.

1. Spatial marking system of a multimedia file that includes:
a ground-based global navigation satellite receiver configured to receive signals from at least three Galileo satellites;
an application server;
an installable client on an electronic device capable of communicating with remote devices/systems via one or more wired and/or wireless networks/technologies and equipped with/connected to a global navigation satellite receiver configured to receive signals from at least three Galileo satellites;
the ground-based global navigation satellite receiver being configured to:
receive:
I/NAV messages of the Galileo E1-B channel from at least three Galileo satellites and
timestamps from a trusted Network Time Protocol server;
transmit to the application server:
I/NAV messages of the Galileo E1-B channel received from the at least three Galileo satellites, and
the timestamps received from the trusted Network Time Protocol server;
the client is operable by a user and/or configured to:
generate and/or modify the multimedia file;
generate a geolocation metadata comprising a position calculated by the global navigation satellite receiver of the electronic device on which the client is installed;
associate the geolocation metadata with the multimedia file generated and/or modified;
receive:
I/NAV messages of the Galileo E1-B channel from at least three Galileo satellites associated with the position calculated;
a timestamp associated with the multimedia file from the trusted Network Time Protocol server; and
transmit to the application server:
I/NAV messages of the Galileo E1-B channel, the geolocation metadata, the timestamp and the multimedia file generated and/or modified;
the application server being configured to:
extract OSNMA messages from the I/NAV messages received from the ground-based global navigation satellite receiver;
extract a Galileo System Time field from the I/INAV messages received from the ground-based global navigation satellite receiver;
validate OSNMA messages extracted from the I/NAV messages received by the ground-based global navigation satellite receiver by applying a TESLA protocol;
receive from the electronic device:
the I/NAV messages of the Galileo E1-B channel,
the geolocation metadata,
the timestamp and
multimedia file generated and/or modified;
extract OSNMA messages from I/NAV messages received by the electronic device;
compare an OSNMA message extracted from an I/NAV message received by the electronic device with an OSNMA message extracted from an I/NAV message received by the ground-based global navigation satellite receiver and validated using the TESLA protocol, said OSNMA messages having the same Galileo satellite identification and having the same timestamp; said timestamps being compatible, minus a time delta, with the Galileo System Time field extracted by the I/INAV messages received from the ground-based global navigation satellite receiver; and
generate a validation outcome relating to the geolocation metadata based on this comparison.

2. The spatial marking system according to claim 1, comprising a blockchain system;
the blockchain system being configured to receive from the application server and to store:
the I/NAV messages transmitted by the ground-based global navigation satellite receiver to the application server;
the I/NAV messages transmitted by the electronic device to the application server;
the timestamps transmitted by the ground-based global navigation satellite receiver and by the electronic device to the application server;
the multimedia file generated and/or modified;
the geolocation metadata; and
the validation outcome generated.

3. The spatial marking system according to claim 1, comprising a public key infrastructure type server;
the public key infrastructure type server being configured to generate a key pair that includes a public key and a private key, wherein the public key is sent to the client and the private key is sent to the application server;
the client being configured to, before transmitting the Galileo E1-B channel I/NAV messages, the geolocation metadata, the timestamp and the multimedia file generated and/or modified to the application server:
encrypt, using the public key, the Galileo E1-B channel I/NAV messages, the multimedia file, the timestamp, the geolocation metadata associated with said multimedia file generated and/or modified; and
transmit to the application server the encrypted Galileo E1-B channel I/NAV messages, the encrypted geolocation metadata, the encrypted timestamp and the encrypted multimedia file generated and/or modified;
the application server being configured to, before comparing an OSNMA message extracted from an I/NAV message received by the electronic device with an OSNMA message extracted from an I/NAV message received from the ground-based global navigation satellite receiver decrypt, using the private key: the encrypted Galileo E1-B channel I/NAV messages, the encrypted timestamp, the encrypted geolocation metadata and the encrypted multimedia file.

4. The spatial marking system according to claim 1, wherein the client is configured to receive an identification metadata relating to the multimedia file generated and/or modified, said identification metadata being transmitted to the electronic device by an Identity Trusted Provider.

5. The spatial making system according to claim 4, the public key infrastructure type server being configured to generate a key pair that includes a public key and a private key, wherein the public key is sent to the client and the private key is sent to the application server;
the client being configured to, before transmitting to the application server the Galileo E1-B channel I/NAV messages, the geolocation metadata, the timestamp and the multimedia file generated and/or modified and a hash of the multimedia file:
encrypt, using the public key, the Galileo E1-B channel I/NAV messages, the multimedia file, the timestamp, the identification metadata, a hash of the multimedia file and the geolocation metadata associated with said multimedia file generated and/or modified; and
transmit to the application server the encrypted Galileo E1-B channel I/NAV messages, the encrypted multimedia file generated and/or modified, the encrypted timestamp, the encrypted identification metadata, the encrypted hash of the multimedia file and the encrypted geolocation metadata;
the application server being configured to, before comparing an OSNMA message extracted from an encrypted I/NAV message received from the electronic device with an OSNMA message extracted from an I/NAV message received by the ground-based global navigation satellite receiver: decrypt, using the private key: the encrypted Galileo E1-B channel I/NAV messages, the encrypted multimedia file generated and/or modified, the encrypted timestamp, the encrypted identification metadata, the encrypted hash of the multimedia file and the encrypted geolocation metadata.

6. The spatial marking system according to claim 4, wherein the application server is configured to:
validate the timestamp based on the timestamps received by the ground-based global navigation satellite receiver and by the electronic device; and
validate the identification metadata based on the identification metadata received by the electronic device; and
provide, as output, a digital certification of the multimedia file generated and/or modified based on the validation outcome generated and based on the validation of the timestamp and of the identification metadata.

7. The spatial marking system according to claim 6, comprising a blockchain system;
the blockchain system being configured to receive from the application server and to store:
the I/NAV messages transmitted by the ground-based global navigation satellite receiver to the application server;
the I/NAV messages transmitted by the electronic device to the application server;
the timestamps transmitted by the ground-based global navigation satellite receiver and by the electronic device to the application server;
the multimedia file generated and/or modified;
the geolocation metadata;
the identification metadata;
the hash of the multimedia file;
the digital certification of the multimedia file provided as output by the application server; and
the validation outcome generated.

8. The spatial marking system according to claim 1, wherein the application server is configured to compare the OSNMA message extracted from the I/NAV message received by the electronic device with the OSNMA message extracted from the I/NAV message received by the ground-based global navigation satellite receiver and validated using the TESLA protocol based on a comparison of a bit sequence of said OSNMA messages and the same Galileo satellite identifier that transmitted the I/NAV messages to the electronic device and the ground-based global navigation satellite receiver.

9. The spatial marking system according to claim 8, wherein the bit sequence comprises at least 40 bits.

10. A spatial marking system according to claim 1, wherein the application server is configured to validate the OSNMA message extracted from the I/NAV message received by the ground-based global navigation satellite receiver and using the TESLA protocol based on:
a verification of a public key retrieved from a Digital Signature Message-Public Key Retrieval (DSM-PKR);
a verification of a TESLA root key retrieved from a Digital Signature Message-Key Root (DSM-KROOT);
a verification of a TESLA key against a root key or a previously authenticated key;
a verification of a message authentication code key (MACK) structure;
an Authentication Data & Key Delay (ADKD) sequence;
a MAC Sequence (MACSEQ) value;
a Flexible (FLX) tag;
a verification of the ADKD 0, ADKD 4 and ADKD 12 tags; and
an authentication of the navigation data.

11. A method for spatial marking of a multimedia file comprising the steps of:
a) extracting a Galileo System Time field from the I/INAV messages transmitted to a ground-based global navigation satellite receiver by at least three Galileo satellites;
b) extracting the OSNMA messages from the I/INAV messages of the Galileo E1-B channel transmitted to the ground-based global navigation satellite receiver by at least three Galileo satellites;
c) validating the OSNMA messages extracted from the I/INAV transmitted to the ground-based global navigation messages satellite receiver from at least three Galileo satellites using a TESLA protocol;
d) extracting the OSNMA messages from the I/NAV messages of the Galileo E1-B channel transmitted by at least three Galileo satellites to an electronic device;
e) comparing the OSNMA messages of the ground-based global navigation receiver with the OSNMA messages of the electronic device; said OSNMA messages of the ground-based global navigation receiver and from the electronic device having the same Galileo satellite identifier and having the same timestamp; said timestamp being compatible, minus a time delta, with the Galileo System Time field extracted;
f) generating a validation outcome concerning a geolocation metadata associated with the multimedia file on the basis of this comparison; said geolocation metadata comprising a position calculated by a global navigation satellite receiver of the electronic device; and
g) storing, on a blockchain system, the generated validation outcome, the I/NAV messages of the ground-based global navigation satellite receiver, the I/NAV messages of the electronic device, the timestamps and the multimedia file.

12. The method according to claim 11, wherein the timestamps are generated by a trusted Network Time Protocol server.

13. The method according to claim 11, comprising the steps of:
generating a key pair that includes a public key and a private key, wherein the public key is used to, prior to step d), encrypt: the multimedia file, the electronic device's I/NAV messages, an identification metadata associated with the multimedia file, a timestamp associated with the multimedia file, a geolocation metadata associated with the multimedia file and a hash associated with said multimedia file;
decrypt, prior to step d), the encrypted Galileo E1-B channel I/NAV messages, the encrypted identification metadata, the encrypted timestamp, the encrypted geolocation metadata, the encrypted multimedia file and the encrypted hash;
wherein step g) of storing comprises:
storing the identification metadata and hash on the blockchain system.

14. The method according to claim 11, wherein the identification metadata is generated by an Identity Trusted Provider.

15. The method according to claim 11, wherein step e) comprises comparing a sequence of bits of said first and second OSNMA messages of the electronic device and the ground-based global navigation satellite receiver and the same identifier of the Galileo satellite that transmitted the I/NAV messages to the electronic device and the ground-based global navigation satellite receiver.

16. The method according to claim 15, wherein the bit sequence comprises at least 40 bits.
